(19) United States
(12) Patent Application Publication
(10) Pub. No.: US 2018/0065831 A1
(43) Pub. Date: Mar. 8, 2018

(54) ELEVATOR

(71) Applicant: Kone Corporation, Helsinki (FI)

(72) Inventor: Petteri VALJUS, Helsinki (FI)

(73) Assignee: Kone Corporation, Helsinki (FI)

(21) Appl. No.: 15/653,827

(22) Filed: Jul. 19, 2017

(30) Foreign Application Priority Data
Sep. 2, 2016 (EP) 16187025.8

(51) Int. Cl. B66B 11/00; B66B 11/08; B66B 7/06; B66D 1/14; B66B 1/30

(52) U.S. Cl. CPC B66B 11/008; B66B 11/08; B66B 1/30; B66B 7/06; B66D 1/14; B66B 11/0045

(57) ABSTRACT

The invention relates to an elevator comprising a hoistway, a vertically movable elevator car, a vertically movable counterweight at least one first rope interconnecting the car and counterweight and passing around one or more rope wheels mounted in proximity of the upper end of the hoistway, the weight of the elevator car being arranged to exert an upwards directed pull on the counterweight via said first rope, and the weight of the counterweight being arranged to exert an upwards directed pull on the elevator car via said first rope. The elevator further comprises a motor-driven winding device connected at least with the car or the counterweight for exerting a vertically directed pull on said only one of the car and counterweight for thereby changing the balance between the car and counterweight.

### FIELD OF THE INVENTION

This application claims priority to European Patent Application No. 16187025.8 filed on Sep. 2, 2016, the entire contents of which are incorporated herein by reference.

The invention relates to an elevator for vertically transporting passengers and/or goods.

### BACKGROUND OF THE INVENTION

Conventionally, an elevator for passenger or freight transport comprises an elevator car and a counterweight, which are vertically movable in a hoistway. These elevator units are typically interconnected by one or more suspension ropes passing around one or more rope wheels mounted in proximity of the upper end of the hoistway. The rope wheels are thereby higher than these elevator units and can provide the reaction force needed for suspension of the aforementioned elevator units. For providing force for moving the suspension ropes, and thereby also for the elevator car and a counterweight, one of the wheels is typically a drive wheel engaging the suspension ropes.

One constant in elevator design is that they need to be designed to be extremely safe. There are also numerous additional highly valued aims such as ones related to performance and space consumption. Known elevators have had a drawback that they are difficult to design sufficiently energy efficient and mountable in a small space, yet at the same time having a large car interior space and low top and bottom clearances. The design has become either complex or the motorization as well as the roping systems have required lots of space. In general, compromises have been made on at least some of these variables. There are also multiple other variables in design wherein compromising has been needed, such as size and positioning of the machine room. Further challenge has been that variability of the elevator to different needs has been difficult due to demanding layouts and difficulties in setting the balancing percent of the counterweight optimal for each individual elevator.

### BRIEF DESCRIPTION OF THE INVENTION

The object of the invention is to introduce a new elevator wherein one or more of the above mentioned drawbacks and/or drawbacks discussed or implied elsewhere in the description can be alleviated. The object is particularly to introduce a new elevator which is safe, energy efficient, simple, space-efficient and cost effective to manufacture. Embodiments are presented, inter alia, where the above mentioned are achieved with simple roping configuration, small and relatively freely positionable machinery providing motorization for the elevator. Embodiments are presented, inter alia, where motor torque requirements of the motor are undemanding, and the physical size of the motor and the power transmission from the motor forward to a movable elevator unit are very compact.

It is brought forward a new elevator comprising a hoistway, an elevator car vertically movable in said hoistway, a counterweight vertically movable in said hoistway, at least one first rope interconnecting the car and counterweight and passing around one or more rope wheels mounted in proximity of the upper end of the hoistway, the weight of the elevator car being arranged to exert an upwards directed pull on the counterweight via said at least one first rope, and the weight of the counterweight being arranged to exert an upwards directed pull on the elevator car via said at least one first rope. The elevator further comprises a motor-driven winding device connected with at least the car or the counterweight such that it can exert a vertically directed pull on said car or said counterweight for thereby changing the balance between the car and counterweight. With this solution one or more of the above mentioned objects can be achieved. With the balancing and suspension function being substantially separate from the motorization as described above, the motor-driven winding device can be designed compact and positioned without requiring lots of space. The small size thereof and the relatively small forces that it needs to exert on the elevator unit facilitate compactness of the equipment. The elevator can be even manufactured without a machine room. The suspension and balancing being provided substantially with other means, makes it possible that a winding device can be utilized without technical problems as the primary means for controlling car movement. In particular, it is possible that one or more concerning technical variables of the motor-driven winding device such as the number of ropes, safety factors, space consumption, mounting equipment, motor properties, speed and noise can be alleviated to such degree that an elevator is achieved which is safe, energy efficient, simple, space-efficient and cost effective to manufacture. Preferable further details are introduced in the following, which further details can be combined with the elevator individually or in any combination.

In a preferred embodiment, the elevator is machineroomless.

In a preferred embodiment, the motor-driven winding device is mounted inside the hoistway.

In a preferred embodiment, the motor-driven winding device is connected with only one of the car and counterweight for exerting a vertically directed pull on said only one of the car and counterweight for thereby changing the balance between the car and counterweight. By connecting the motor-driven winding device on only one of said elevator units, its construction, positioning and operation are simplified.

In a preferred embodiment, the motor-driven winding device comprises at least one second rope connected with only one of the car and counterweight and extending vertically from it, a rotatable winding drum, on which winding drum the at least one second rope has been fixed, and at least one motor for rotating said winding drum, the motor-driven winding device being arranged to exert said vertically directed pull on said car or said counterweight by winding the at least one second rope around the winding drum.

In a preferred embodiment, the motor-driven winding device is arranged to relieve said vertically directed pull by unwinding or at least allowing unwinding of the at least one second rope away from around said winding drum.

In a preferred embodiment, the motor-driven winding device comprises only one of said second ropes. On the other hand, the elevator preferably comprises plurality of said first ropes.

In a preferred embodiment, each said second rope is a belt. The first rope(s) can be different than the second rope(s).

In a preferred embodiment, the first ropes are non-driven ropes, i.e. the elevator does not comprise driving means directly acting on said first ropes.

In a preferred embodiment, the motor-driven winding device is the sole motor-driven means of the elevator for exerting a vertically directed pull on the car or counterweight.

In a preferred embodiment, the second rope is arranged to be wound around said winding drum in spiral form.

In a preferred embodiment, the second rope is arranged to be wound around said winding drum in two dimensional spiral form, i.e. aligned with the rotational plane of the winding drum. Then, the space consumption of the motorization becomes very compact.

In a preferred embodiment, the winding drum comprises flanges between which in axial direction of the winding drum the second rope is arranged to be wound. Thus, it is possible to be placed in a space where space consumption is critical, such as inside an upper or lower end of a hoistway.

In a preferred embodiment, the winding drum comprises a gear wheel in fixed connection therewith, in particular integral therewith or fixed immovably thereon, and the motor comprises a drive shaft, in particular one fixedly connected with the rotor of the motor, and a gear wheel fixedly on the drive shaft and meshing with the gear wheel of the winding drum. The gear ratio is preferably set high, such that tooth number Z1 gear wheel of the winding drum/tooth number Z2 of gear wheel of the motor shaft is great, such greater than 3 or greater than 5. Great gear ratio facilitates making the motor size compact.

In a preferred embodiment, the gear wheel of the winding drum is one of the flanges of the winding drum. Thus, gear ratio can be simply set high, such that tooth number Z1 gear wheel of the winding drum/tooth number Z2 of gear wheel of the motor shaft is great, such greater than 3 or greater than 5.

In a preferred embodiment, the winding device comprises a brake arranged to act on the gear wheel of the winding drum.

In a preferred embodiment, the winding drum is mounted rotatably on a stationary structure, such as on a stationary structure of the building or a stationary structure mounted thereon, whereby it is rotatable in a fixed location.

In a preferred embodiment, the stationary structure on which the winding drum is mounted rotatably inside the upper or lower end of the hoistway. With the balancing and suspension function being substantially separate from the motorization as described above, the motor-driven winding device can be designed such compact that the winding drum thereof can be mounted inside the upper or lower end of the hoistway. The small size and the relatively small forces that the winding device needs to exert on the elevator unit facilitate the compactness of the components thereof, particularly the motor and the winding drum, and their positioning such that they do not dramatically delimit the length of the path of the movable elevator units.

In a preferred embodiment, the stationary structure on which the winding drum is mounted rotatably is a guide rail along which the car or counterweight is arranged to travel in the hoistway. With the balancing and suspension function being substantially separate from the motorization as described above, the motor-driven winding device can be designed such compact that it can be mounted inside the hoistway on a guide rail. The small size and the relatively small forces that the winding device needs to exert on the elevator unit facilitate the compactness of the components thereof, particularly the motor and the winding drum, and their positioning such that they do not dramatically delimit the length of the path of the movable elevator units.

In a preferred embodiment, the elevator comprises mounting means mounting the motor and the winding drum on the stationary structure, preferably a guide rail of the elevator.

In a preferred embodiment, said first rope is a metal wire rope round in cross-section.

In a preferred embodiment, the second rope is arranged to wind around the winding drum when the winding drum rotates in its first rotation direction, and unwind away from around the winding drum when the winding drum rotates in its second rotation direction.

In a preferred embodiment, the motor-driven winding device is arranged to perform said unwinding by controlling rotation of the winding drum in its second rotation direction with the motor. This can include motor braking when needed. Thereby, both running directions of the elevator units are controllable by controlling the motor, in particular by controlling torque of the motor.

In a preferred embodiment, said one of the car and counterweight is the car. In one preferred alternative, said vertically directed pull is an upwards directed pull. Then preferably the weight of the car is greater than the weight of the counterweight. In one other preferred alternative, said vertically directed pull is a downwards directed pull. Then preferably the weight of the car is smaller than the weight of the counterweight.

In a preferred embodiment said one of the car and counterweight is the counterweight. In one preferred alternative, said vertically directed pull is an upwards directed pull. Then preferably the weight of the counterweight is greater than the weight of the car. In one other preferred alternative, said vertically directed pull is a downwards directed pull. Then preferably the weight of the counterweight is smaller than the weight of the car.

In a preferred embodiment, the elevator comprises at least one third rope interconnecting the car and counterweight and passing around one or more rope wheels mounted in proximity of the lower end of the hoistway.

In a preferred embodiment, the winding drum is mounted rotatably on a stationary structure, such as on a stationary structure of the building or a stationary structure mounted thereon whereby it is rotatable in a fixed location. Most preferably the stationary structure is a guide rail of the elevator. The elevator can be further implemented for example such that an end of said at least one second rope is fixed on said one of the car and counterweight. An alternative is that an end of said at least one second rope is fixed on a stationary structure, such as on a stationary structure of the building or a stationary structure mounted thereon and the rope passes around a rope wheel mounted on said one of the car and counterweight.

In a preferred embodiment, the aforementioned vertically directed pull (the pull that the motor-driven winding device is configured for exerting on the car or counterweight) is greater than 2000 N, more preferably greater than 5000 N. Hereby, the pull is adequate for considerably shifting the balance between the elevator car and counterweight, and the winding device can serve as the primary means for controlling car movement.

In a preferred embodiment, said at least one motor for rotating said winding drum comprises plurality of motors for rotating said winding drum. There can be two or more motors, such as four, for example. Preferably, the configuration is implemented such that each motor comprises a drive shaft and a gear wheel fixedly on the drive shaft, and meshing with the gear wheel of the winding drum. All the motors are preferably mounted by common mounting means on a stationary structure. The stationary structure is most preferably a guide rail along which the elevator car or the counterweight is arranged to travel in the hoistway.

As an alternative to connecting the motor-driven winding device with only one of the car and counterweight, it could alternatively be connected with both the car and the counterweight such that it can exert a vertically directed pull thereon. The advantage of this solution is that this facilitates the system becoming more independent of its balancing percentage. Then, the motor-driven winding device comprises at least one further rope connected with only one of the car and counterweight and extending vertically from it. The at least one second rope is particularly connected to the car and the at least one further rope to the counterweight, or vice versa. This is further implemented such that the motor-driven winding device comprises second rotatable winding drum fixedly and coaxially connected with the aforementioned winding drum, on which second rotatable winding drum the at least one further rope has been fixed, the motor-driven winding device being arranged to exert said vertically directed pull on said car or the counterweight, whereto the further rope is connected, by winding the at least one further rope around the second winding drum. The second rope 6 and the further rope are then oppositely wound. Thereby, the second rope 6 is arranged to wind around the winding drum and the further rope is arranged to unwind away from around the second winding drum when the winding drum rotates in its first rotation direction, and the second rope is arranged to unwind away from around the winding drum and the further rope is arranged to wind around the second winding drum when the winding drum rotates in its second rotation direction.

The elevator is preferably such that the car thereof is configured to serve two or more vertically displaced landings. The elevator is preferably configured to control movement of the car in response to signals from user interfaces located at landing(s) and/or inside the car so as to serve persons on the landing(s) and/or inside the elevator car. Preferably, the car has an interior space suitable for receiving a passenger or passengers or goods, and the car can be provided with a door for forming a closed interior space.

### BRIEF DESCRIPTION OF THE DRAWINGS

In the following, the present invention will be described in more detail by way of example and with reference to the attached drawings, in which

FIG. 1 illustrates a first preferred embodiment of an elevator.

FIG. 2 illustrates a second preferred embodiment of an elevator.

FIG. 3 illustrates a third preferred embodiment of an elevator.

FIG. 4 illustrates a fourth preferred embodiment of an elevator.

FIG. 5 illustrates three dimensionally preferred details of the motor-driven winding device of FIGS. 1 to 4.

FIG. 6 illustrates a cross section of the motor-driven winding device of FIG. 5 as viewed in axial direction of the winding drum of the motor-driven winding device.

FIG. 7 illustrates details of the motor-driven winding device of FIGS. 5 and 6 according to a first preferred alternative.

FIG. 8 illustrates details of the motor-driven winding device of FIGS. 5 and 6 according to a second preferred alternative.

FIGS. 9 and 10 illustrate further preferred details of the motor-driven winding device illustrated in FIGS. 5 and 6.

FIG. 11 illustrates a preferred layout of the elevator as viewed in vertical direction.

FIGS. 12 and 13 illustrate an embodiment where the motor-driven winding device is connected with both the car and counterweight.

The foregoing aspects, features and advantages of the invention will be apparent from the drawings and the detailed description related thereto.

### DETAILED DESCRIPTION

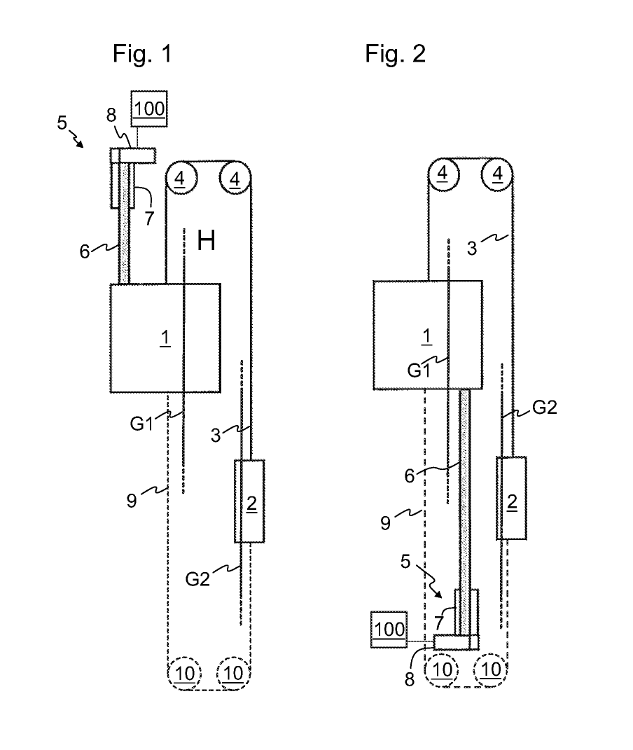

FIGS. 1 to 4 each discloses a preferred embodiment of an elevator.

In each embodiment, the elevator comprises a hoistway H, an elevator car 1 vertically movable in the hoistway H and a counterweight 2 vertically movable in the hoistway H beside the elevator car 2. The elevator comprises at least one first rope 3 interconnecting the car 1 and counterweight 2 and passing around one or more rope wheels 4 mounted in proximity of the upper end of the hoistway H. The one or more rope wheels 4 are thereby higher than these elevator units and can provide the reaction force needed for suspension of the aforementioned elevator units. In the presented embodiments, there are two of said rope wheels 4, but there could alternatively be any other number of rope wheels such as only one. The weight of the elevator car 1 is arranged to exert an upwards directed pull on the counterweight 2 via said at least one first rope 3, and the weight of the counterweight 2 is arranged to exert an upwards directed pull on the elevator car 1 via said first rope 3. Thereby, these two elevator units to a certain degree balance each other. The balancing effect of these elevator units, when the car 1 is empty, is largely set by selected weight of these elevator units. In use, the prevailing load state of the elevator car, i.e. number of passengers inside the car 1, has an additional effect on the actual balance. The elevator further comprises a motor-driven winding device 5 connected with only one of the car 1 and counterweight 2 such that it can exert a vertically directed pull on only one of the car 1 and counterweight 2 for thereby changing the balance between the car 1 and counterweight 2. Thus, the motor-driven winding device 5 can be used to control the movement of the elevator car 1.

The motor-driven winding device 5 comprises at least one second rope 6 connected with only one of the car 1 and counterweight 2 and extending vertically from it, a rotatable winding drum 7, on which winding drum 7 the at least one second rope 6 has been fixed, and at least one motor 8 for rotating said winding drum 7, the motor-driven winding device 5 being arranged to exert said vertically directed pull on one of the car 1 and counterweight 2 by winding the at least one second rope 5 around the winding drum 7. The second rope 6 is arranged to wind around the winding drum 7 when the winding drum 7 rotates in its first rotation direction, and unwind away from around the winding drum 7 when the winding drum 7 rotates in its second rotation direction.

The elevator further comprises a control 100 for automatically controlling rotation of said at least one motor 8, whereby the movement of the car 1 is made automatically controllable.

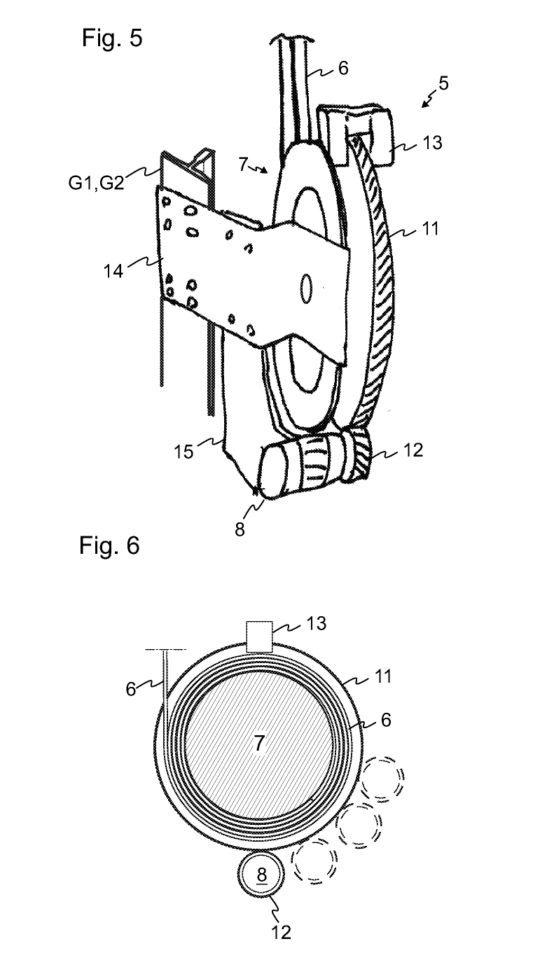

In the preferred embodiments, the winding drum 7 is mounted rotatably on a stationary structure, such as on a stationary structure of the building or a stationary structure mounted thereon, whereby it is rotatable in a fixed location. Said stationary structure can be a guide rail of the elevator for guiding one of the elevator units, i.e. the car 1 or the counterweight 2, which guide rail on the other hand can be mounted on the hoistway wall. FIG. 5 illustrates preferred details of how the winding drum 7 can be mounted on the guide rail.

The motor-driven winding device 5 is arranged to relieve said vertically directed pull by unwinding or at least allowing unwinding of the at least one second rope 6 away from around said winding drum 7. When the balance situation is such that the second rope is tensioned due to it, the unwinding is realized by mere allowing the winding drum to rotate 7. The motor-driven winding device 5 is preferably arranged to perform said unwinding by controlling rotation of the winding drum 7 in its second rotation direction with the at least one motor 8. Thereby, both running directions of the elevator units are controllable by controlling the at least one motor 8, in particular by controlling torque of the at least one motor 8. Said at least one motor 8 for rotating said winding drum 7 can comprise only one motor or plurality of motors 8 for rotating said winding drum 7. When there are plurality of said motors 8, very small motors can be used. This is advantageous as the space consumption of the winding device 5 is reduced and it is cheaper to produce. The compactness achieved is particularly advantageous for enabling positioning of the winding device 5 inside the hoistway without dramatically delimiting the length of the path of the movable elevator units.

In the embodiments presented in FIGS. 1 and 2, said one of the car 1 and counterweight 2 on which the motor-driven winding device 5 can exert a vertically directed pull is the car 1.

In the embodiment of FIG. 1, the winding device 5 is arranged to pull car upwards, whereby said vertically directed pull is an upwards directed pull. In this embodiment, preferably the weight of the car is greater than the weight of the counterweight 2. Thus, the at least one second rope 6 is under tension independent of car load, whereby the car movement both upwards and downwards is well controllable with the winding device 5. In this embodiment, the weight difference of the car and counterweight does not need to be great, whereby the elevator can be made very economical when its use involves frequent runs with small loads and/or with the car empty.

In the embodiment of FIG. 2, the winding device 5 is arranged to pull car downwards, whereby said vertically directed pull is an downwards directed pull. In this embodiment, preferably the weight of the car 1 is smaller than the weight of the counterweight 2. Thus, the at least one second rope 6 is under tension independent of car load, whereby the car movement both upwards and downwards is well controllable with the winding device 5.

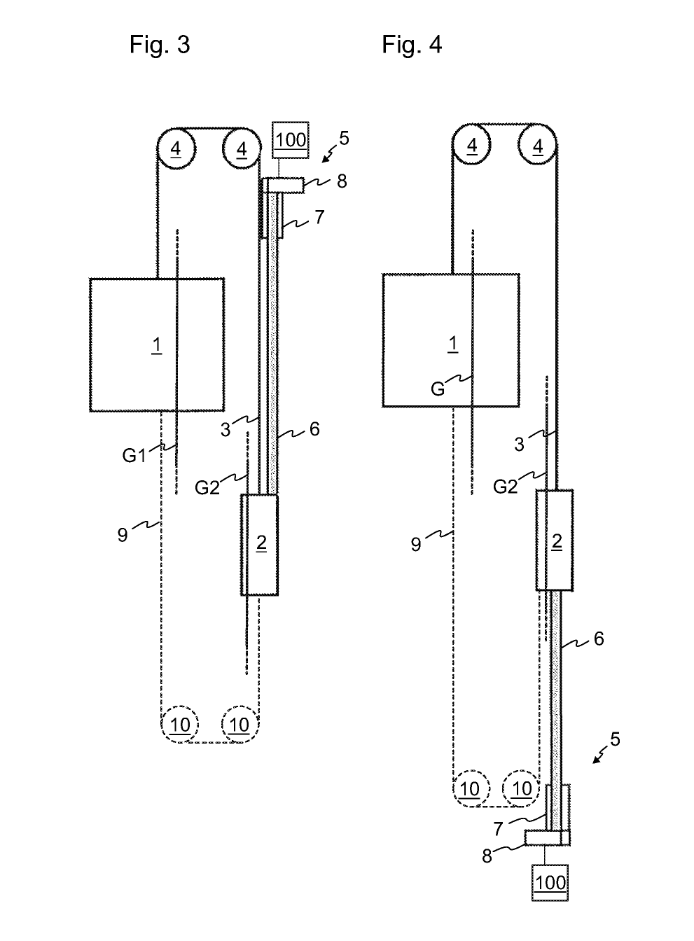

In the embodiments presented in FIGS. 3 and 4, said one of the car 1 and counterweight 2 on which the motor-driven winding device 5 can exert a vertically directed pull is the counterweight 2.

In the embodiment of FIG. 3, the winding device 5 is arranged to pull the counterweight 2 upwards, whereby said vertically directed pull is an upwards directed pull. In this embodiment, preferably the weight of the counterweight 2 is greater than the weight of the car 1. Thus, the at least one second rope 6 is under tension at least with an empty car. More preferably, the weight of the counterweight 2 is greater than the weight of the car 1 plus the nominal load of the elevator. Thus, the at least one second rope 6 is under tension independent of car load, whereby the car movement both upwards and downwards is well controllable with the winding device 5.

In the embodiment of FIG. 4, the winding device 5 is arranged to pull the counterweight 2 downwards, whereby said vertically directed pull is a downwards directed pull. In this embodiment, preferably the weight of the counterweight 2 is smaller than the weight of the car 1. Thus, the at least one second rope 6 is under tension independent of car load, whereby the car movement both upwards and downwards is well controllable with the winding device 5. In this embodiment, the weight difference of the car and counterweight does not need to be great, whereby the elevator can be made very economical when its use involves frequent runs with small loads and/or with the car empty.

For the purpose of guiding the elevator car 1, the elevator comprises vertically oriented guide rails G1. The guide rails for guiding the elevator car 1 then preferably comprise two guide rails G1 extending vertically on opposite sides of the elevator car 1. Likewise, for the purpose of guiding the elevator counterweight, the elevator comprises vertically oriented guide rails G2. The guide rails G2 for guiding the counterweight 2 preferably comprise two guide rails G2 extending vertically on opposite sides of the counterweight 2.

FIGS. 5 and 6 illustrate preferred details for implementing any of the solutions referred to anywhere in this application. It is preferable that the second rope 6 is arranged to be wound around said winding drum in spiral form. Particularly, it is preferable that the second rope 6 is arranged to be wound around said winding drum in two dimensional spiral form, i.e. aligned with the rotational plane of the winding drum. Then, the space consumption of the motorization becomes very compact. FIG. 5 illustrates preferred details for the motorization components of the motor-driven winding device 5. The two dimensional winding is implemented by providing flanges 16 comprised in the winding drum 7 between which flanges 11,16 in axial direction of the winding drum the second rope 6 is arranged to be wound. Thus, the desired two dimensional winding is ensured. In FIG. 6, it is made visible (with broken lines) how the motor-driven winding device 5 can be when said at least one motor 8 for rotating said winding drum 7 comprises plurality of motors 8 for rotating said winding drum 7.

The motorization components of the winding device 5 are further made compact by particular power transmission illustrated in FIG. 5. The winding drum 7 comprises a gear wheel 11 in fixed connection therewith, i.e. integral or fixed immovably thereon, and the motor 8 comprises a drive shaft fixedly connected with the rotor of the motor and a gear wheel 12 fixedly on the drive shaft and meshing with the gear wheel 11 of the winding drum 7. Hereby, torque requirements of the motor 8 can be alleviated and the physical size of the motor can be reduced as well as its positioning made in very compact manner, whereby the winding device 5 can be relatively freely positioned in the building. The compactness of the overall structure has been facilitated by making the gear wheel of the winding drum 7 one of the flanges 11,16 of the winding drum 7. To ensure safety and additional means for controlling the speed of unwinding, the winding device 5 comprises a brake arranged to act on the gear wheel of the winding drum 7. As illustrated, in the preferred embodiment, the winding drum 7 is mounted rotatably on a stationary structure, which is in this case a guide rail G1,G2 along which the car 1 or counterweight 2 is arranged to travel in the hoistway H. The mounting means 14,15 are in this case in the form of a fixing frame fixing the motor 8 as well as the winding drum 7 on the stationary structure, i.e. the guide rail G1 or G2 in this case. Accordingly, the same fixing frame 14,15 fixes the motor well as the winding drum 7 on the guide rail G. The fixing frame 14,15 comprises brackets 14 and 15. The motor 8 is preferably an electric motor.

One advantage achievable with the presented solution is that the motorization of the elevator can be designed lightly. Thus, the winding device 5 and thereby the second ropes 6 thereof, need not in the presented solution be made robust as they are primarily used to shift the balance situation between the car 1 and counterweight 2. As they do not transmit the tension between the car 1 and counterweight 2, great portion of the tension is beared by the first ropes 3. Preferably, the elevator comprises plurality of said first ropes 3, and the motor-driven winding device 5 comprises a smaller number of ropes 6, most preferably only one rope, i.e. said second rope 6. This provides that the suspension is provided with plurality of ropes ensuring high suspension abilities for the elevator whereas the motorization function can be made as simple and light as possible.

The elevator can comprise at least one third rope (9) interconnecting the car and counterweight, hanging from these and passing around one or more rope wheels (10) mounted in proximity of the lower end of the hoistway (H). The third rope(s) are not necessary, but they can be advantageous for avoidance for removing unbalance caused in position change of elevator units 1 and 2, which may be important in accurately adjusted balance situations, such as when the weight difference of the car and counterweight is set to be minimal. It is also advantageous in braking situation for transmitting braking forces between the elevator units 1 and 2.

The first ropes 3 are preferably non-driven ropes 3, i.e. the elevator does not comprise driving means directly acting on said first ropes 3. Accordingly, all the rope wheels 4 around which the first rope(s) 3 pass are non-driven rope wheels.

In the preferred embodiments, the motor-driven winding device 5 is the sole motor-driven means of the elevator for exerting a vertically directed pull on the car 1 or the counterweight 2. This is preferred as the solutions provide that additional means are not necessary. However, it is possible to implement the elevator with another motor-driven winding device 5, for example. In this case, the two motor-driven winding devices would then be arranged to exert a vertically directed pull on said one of the car 1 and counterweight 2, said vertical directions being then opposite to each other, i.e. one being upwards directed and the other downwards directed. This would provide complete freedom in adjusting of the balance between the car 1 and counterweight 2.

As mentioned, in the preferred embodiments, the winding drum 7 is mounted rotatably on a stationary structure whereby it is rotatable in a fixed location. Each said at least one second rope is then connected with said one of the car 1 and counterweight 2 either directly 1:1 suspension ratio or via a rope wheel mounted on the elevator unit in question. In the preferred embodiments, as illustrated, said 1:1 ratio has been implemented such that an end of said at least one second rope 6 is fixed on said one of the car 1 and counterweight 2. Other suspension ratios (e.g. 2:1) could be implemented such that an end of said at least one second rope 6 is fixed on a stationary structure, such as on a stationary structure of the building or a stationary structure mounted thereon and the rope passes around a rope wheel mounted on said one of the car 1 and counterweight 2.

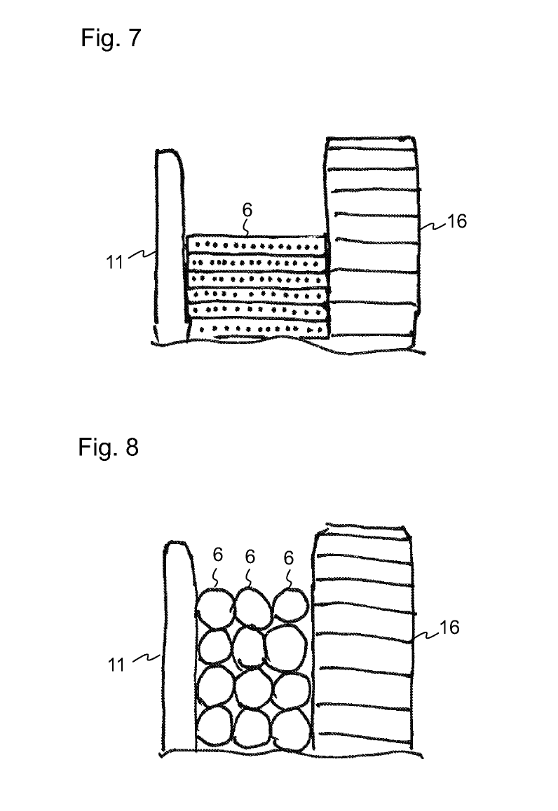

FIG. 7 illustrates preferred details of the motor-driven winding device 5 of FIGS. 5 and 6 according to a first preferred alternative. The Figure presents a partial cross sectional view of how the second rope 6 is constructed as well as how it has been wound in several rounds around the winding drum 7. In this embodiment, the second rope 6 is a belt, whereby it has width substantially larger than thickness thereof in transverse direction of the rope 6. As illustrated, the second rope 6 is arranged to be wound around said winding drum in two dimensional spiral form, i.e. aligned with the rotational plane of the winding drum. As visible in FIG. 7, the construction achieved in axial direction of the winding drum 7 is very compact. The compactness of the two dimensional winding is even further facilitated by rope structure. The compactness of the two dimensional winding is even further facilitated by position control of the second rope by flanges 11 and 16 between which flanges 11,16 in axial direction of the winding drum 7 the second rope 6 is arranged to be wound. The compactness of the two dimensional winding is even further facilitated by that one of the flanges is formed by a gear wheel 11 via which torque is arranged to be transmitted from a motor 8 to the winding drum 7.

The width/thickness ratio of the belt-shaped second rope 6 is preferably at least at least 4, more preferably at least 5 or more, even more preferably at least 6, even more preferably at least 7 or more, yet even more preferably at least 8 or more. Wide structure facilitates settling of the rope around the winding drum 7 in a controlled manner. Particularly, two dimensional spiral configuration is simple to achieve. Preferably, said second rope 6 comprises one or more load bearing members extending parallel with the longitudinal direction of the rope unbroken throughout the length of the rope. Said one or more load bearing members is/are preferably embedded in a polymer coating, preferably elastomer coating. In the embodiment of FIG. 7, only one second rope is used, which is advantageous as when only one rope needs to be wound around the winding drum 7, the axial control of the second rope becomes simple, efficient and reliable with the flanges 11,16 placed on opposite sides thereof in axial direction of the winding drum 7.

When the second rope 6 is a belt, the said first rope 3 is preferably a metal wire rope round in cross-section, as this construction is simple and cheap, and as the first rope does not serve primarily the driving function of the elevator, these features are advantageous. It is of course possible that the first ropes 3 can be of any other type such as even similar to the second ropes 6.

FIG. 8 illustrates preferred details of the motor-driven winding device 5 of FIGS. 5 and 6 according to a second preferred alternative. The Figure presents a partial cross sectional view of how the second rope 6 is constructed as well as how it has been wound in several rounds around the winding drum 7. In this embodiment, the second rope 6 is round in cross section, and said at least one second rope comprises plurality of said second ropes 6, in this case three. The second rope can be a metal wire rope round in cross-section, for example. As illustrated, each second rope 6 is arranged to be wound around said winding drum 7 in two dimensional spiral form, i.e. aligned with the rotational plane of the winding drum. The second ropes 6 pass along parallel planes that are displaced in axial direction of the winding drum 7. As visible in FIG. 8, the construction achieved in axial direction of the winding drum 8 is very compact. The compactness of the two dimensional winding is even further facilitated by position control of the second rope by flanges 11 and 16 between which flanges 11,16 in axial direction of the winding drum 7 the second ropes 6 are arranged to be wound. The compactness of the two dimensional winding is even further facilitated by that one of the flanges is formed by a gear wheel 11 via which torque is arranged to be transmitted from a motor 8 to the winding drum 7.

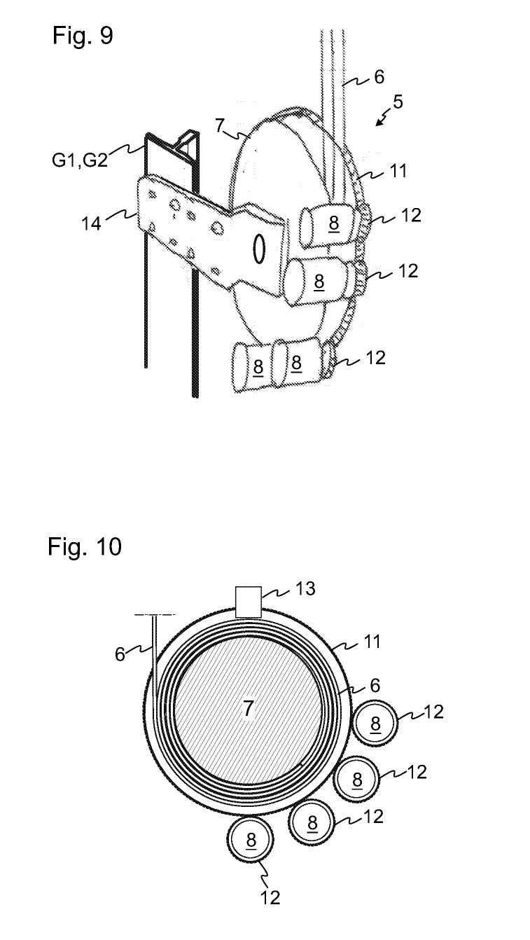

FIGS. 9 and 10 illustrate further the motor-driven winding device 5 when said at least one motor 8 for rotating said winding drum 7 comprises plurality of motors 8 for rotating said winding drum 7. The number of said motors 8 can be two or more. In the preferred embodiment illustrated, there are four of said motors 8. Each motor 8 comprises a drive shaft and a gear wheel 12 fixedly on the drive shaft, and meshing with the gear wheel 11 of the winding drum 7. The solution is in line with what is described in context of FIGS. 5 and 6. Accordingly, the motors 8 are preferably all electric motors. The motors 8 are furthermore preferably mounted by common mounting means 14,15 on a guide rail G1,G2. The motors 8 can be mounted on the bracket 15 disclosed in FIG. 6.

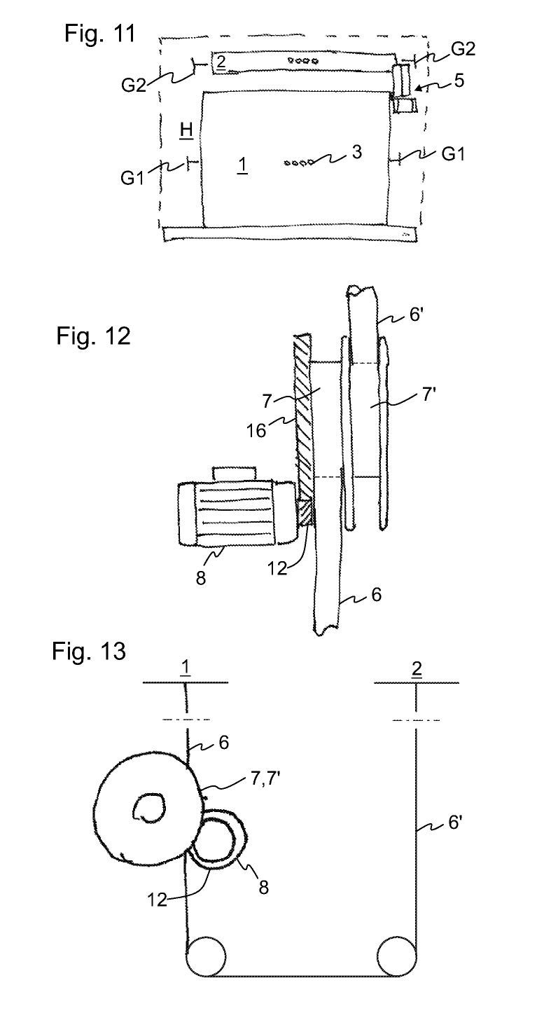

FIG. 11 illustrates a preferred layout of the elevator as viewed in vertical direction. In this layout, the motor-driven winding device 5 is mounted inside the hoistway H.

In the above, embodiments are described wherein the motor-driven winding device 5 is connected with only one of the car 1 and counterweight 2 for exerting a vertically directed pull on said only one of the car 1 and counterweight 2 for thereby changing the balance between the car 1 and counterweight 2. However, the motor-driven winding device 5 could alternatively be connected in this manner with both the car 1 and the counterweight 2. This kind of embodiment has been disclosed in FIGS. 12 and 13.

The motor-driven winding device 5 comprises at least one further rope 6′ connected with the counterweight 2 and extending vertically from it. The at least one second rope is connected to the car 1 and the at least one further rope 6′ to the counterweight 2, or vice versa. Except for the further rope 6′ and the additional arrangements for moving it, in the example of FIG. 13 the configuration is otherwise similar to that of FIG. 2. The motor-driven winding device 5 comprises a second rotatable winding drum 7′ fixedly and coaxially connected with the aforementioned winding drum 7, whereby these rotate together. The at least one further rope 6′ has been fixed on the second rotatable winding drum 7′. The motor-driven winding device 5 is arranged to exert said vertically directed pull on the counterweight 2 by winding the at least one further rope 6′ around the second winding drum 7′. The second rope 6 and the further rope 6′ are oppositely wound, whereby the second rope 6 is arranged to wind around the winding drum 7 and the further rope 6′ is arranged to unwind away from around the second winding drum 7′ when the winding drum 7 rotates in its first rotation direction, and the second rope 6 is arranged to unwind away from around the winding drum 7 and the further rope 6′ is arranged to wind around the second winding drum 7′ when the winding drum 7 rotates in its second rotation direction. In this example, at least one second rope 6 and the at least one further rope 6′ have been connected to the car 1 and counterweight, respectively, following the configuration presented in FIG. 2. However, correspondingly, this embodiment could be implemented following the configuration presented in FIG. 2. The preferred features of the second rope 6 also apply with respect to the further rope 7′. Accordingly, the further rope 6′ is preferably arranged to be wound around said second winding drum 7′ in two dimensional spiral form. It is preferably a belt. Furthermore, there is preferably only one of said further ropes 6′.

In context of the preferred embodiments, advantageous rope types and configuration have been disclosed. It is of course possible that the winding device 5 is implemented with some other number of the second ropes 6 and/or some other structure of the second ropes 6 than what is disclosed in context of the preferred embodiments.

In the preferred embodiments disclosed, the winding drum 7 has been mounted on a stationary structure. It is however of course possible to implement the invention also with an alternative, inverse, configuration wherein the winding drum 7 has been mounted on the elevator car or counterweight, in which case the end of the second rope(s) would be fixed on a stationary structure.

As brought forward, the motor-driven winding device is configured for exerting a vertically directed pull on the car and/or the counterweight. The aforementioned vertically directed pull is preferably greater than 2000 N, more preferably greater than 5000 N. Hereby, the pull is adequately forceful for considerably shifting the balance between the elevator car and counterweight, and it can serve as the primary means for controlling car movement.

In the preferred embodiments discloses, the suspension ratio of the car and counterweight is 1:1. However, these could alternatively be suspended with some other ratio, such as 2:1 or higher.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. An elevator comprising a hoistway, a vertically movable elevator car, a vertically movable counterweight at least one first rope interconnecting the car and counterweight and passing around one or more rope wheels mounted in proximity of the upper end of the hoistway, the weight of the elevator car being arranged to exert an upwards directed pull on the counterweight via said at least one first rope, and the weight of the counterweight being arranged to exert an upwards directed pull on the elevator car via said at least one first rope, wherein the elevator further comprises a motor-driven winding device connected with at least the car or the counterweight for exerting a vertically directed pull on said car or the counterweight for thereby changing the balance between the car and counterweight.

2. An elevator according to claim 1, wherein the motor-driven winding device is connected with only one of the car and counterweight for exerting a vertically directed pull on said only one of the car and counterweight for thereby changing the balance between the car and counterweight.

3. An elevator according to claim 1, wherein the motor-driven winding device comprises at least one second rope connected with only one of the car and counterweight and extending vertically from it, a rotatable winding drum, on which winding drum the at least one second rope has been fixed, and at least one motor for rotating said winding drum, the motor-driven winding device being arranged to exert said vertically directed pull on said car or the counterweight by winding the at least one second rope around the winding drum.

4. An elevator according to claim 3, wherein the motor-driven winding device is arranged to relieve said vertically directed pull by unwinding or at least allowing unwinding of the at least one second rope away from around said winding drum.

5. An elevator according to claim 3 wherein the motor-driven winding device comprises only one of said second ropes.

6. An elevator according to claim 3, wherein said second rope is a belt.

7. An elevator according to claim 3, wherein said second rope is arranged to be wound around said winding drum in two dimensional spiral form.

8. An elevator according to claim 3, wherein the winding drum comprises flanges between which in axial direction of the winding drum each said second rope is arranged to be wound.

9. An elevator according to claim 3, wherein the winding drum comprises a gear wheel in fixed connection therewith, and the motor comprises a drive shaft and a gear wheel fixedly on the drive shaft, and meshing with the gear wheel of the winding drum.

10. An elevator according to claim 8, wherein the gear wheel of the winding drum is one of the flanges of the winding drum.

11. An elevator according to claim 3, wherein the winding drum is mounted rotatably inside the upper or lower end of the hoistway.

12. An elevator according to claim 3, wherein the winding drum is mounted rotatably on a stationary structure.

13. An elevator according to claim 12, wherein the stationary structure on which the winding drum is mounted rotatably is a guide rail along which the elevator car or the counterweight is arranged to travel in the hoistway.

14. An elevator according to claim 2, wherein said one of the car and counterweight is the car and said vertically directed pull is an upwards directed pull and the weight of the car is greater than the weight of the counterweight, or said vertically directed pull is a downwards directed pull and the weight of the car is smaller than the weight of the counterweight.

15. An elevator according to claim 2, wherein said one of the car and counterweight is the counterweight, and said vertically directed pull is an upwards directed pull and the weight of the counterweight is greater than the weight of the car, or said vertically directed pull is a downwards directed pull, and the weight of the counterweight is smaller than the weight of the car.

16. An elevator according to claim 3, wherein said at least one motor for rotating said winding drum comprises plurality of motors for rotating said winding drum.
